(19) United States
(12) Patent Application Publication
(10) Pub. No.: US 2026/0062628 A1
(43) Pub. Date: Mar. 5, 2026

(54) CONVERSION OF WASTE PLASTIC DERIVED PYROLYSIS OIL INTO n-PARAFFIN RICH STEAM CRACKER FEEDSTOCK

(71) Applicant: Chevron U.S.A. Inc., San Ramon, CA (US)

(72) Inventors: Jifei JIA, Hercules, CA (US); Harjeet VIRDI, Missouri City, TX (US); Theodorus Ludovicus Michael MAESEN, Spring, TX (US); Krege CHRISTISON, Martinez, CA (US); Bi-Zeng ZHAN, Albany, CA (US); Sudipto CHAKRABORTY, The Woodlands, TX (US); Ujjal K. MUKHERJEE, Montclair, NJ (US)

(73) Assignee: Chevron U.S.A. Inc., San Ramon, CA (US)

(21) Appl. No.: 19/314,281

(22) Filed: Aug. 29, 2025

Related U.S. Application Data
(60) Provisional application No. 63/688,907, filed on Aug. 30, 2024.

(51) Int. Cl. C10G 65/12; B01J 23/56; B01J 29/70

(52) U.S. Cl. CPC C10G 65/12; B01J 23/56; B01J 29/7003; C10G 2300/1003; C10G 2300/4081

(57) ABSTRACT

A novel process for making n-paraffin rich steam cracker feedstocks from pyrolysis oil derived from waste plastics. The process utilizes a hydrotreating section and a hydrocracking section. Some products can be sent to a steam cracker as feedstocks to make chemicals, while others can be recycled back into the system to improve target product yield. In one embodiment the liquid recycle is designed for better heat management. The system results in the conversion of pyrolysis oil derived from waste plastics into steam cracker feedstock.

### CROSS REFERENCE TO RELATED APPLICATIONS

This application claims priority to U.S. Provisional Application Ser. No. 63/688,907 filed Aug. 30, 2024, the complete disclosure of which is incorporated herein by reference in its entirety.

### TECHNICAL FIELD

This disclosure relates to a system and process for effectively producing steam cracker feedstock from waste plastic derived pyrolysis oil.

### BACKGROUND

Unlike other commonly used materials, plastic can take up to 1,000 years to break down. Thus, when discarded, plastic builds up in the environment, pushing the world closer to a waste plastic management crisis. The world is already on the brink of this crisis, with plastic pollution presenting problems globally. Waste plastic accumulation has been shown to endanger marine wildlife, damage soil, poison groundwater, and cause serious health problems among human populations. Already, 19-23 million tons of plastic waste leaks into aquatic ecosystems each year, polluting lakes, rivers, and seas. Therefore, working to reduce, reuse, and recycle waste plastic, key aspects of a circular economy, will aid to advance the aim of environmental protection.

Many approaches have been developed towards the goal of advancing the circular economy. One such approach relates to the conversion of waste plastic into pyrolysis oil. Using waste plastics in this way reduces the accumulation of waste plastics by reusing and recycling the plastics to create pyrolysis oil. However, common waste plastics, such as candy wrappers, stand-up pouches, potato chip bags, protective packaging, single-use cups, frozen food bags, razors, toothpaste tubes, cotton swabs, and other objects of daily life defy both mechanical recycling and depolymerization. These items are made from multiple plastics that are nearly impossible to separate and mostly comprise polyolefins like polyethylene and polypropylene. These polyolefins have strong carbon-carbon bonds that resist depolymerization. For these mixed plastics, pyrolysis is a viable tool for recovering raw materials and making new polymers. The pyrolysis process is superficially simple. High temperatures are used in the absence of oxygen to break down plastics into a mixture of smaller molecules known as pyrolysis oil. Yet converting the different kinds of plastics that can end up as waste into an uncontaminated feedstock—such as the C₅-C₁₂ paraffins that would be an ideal naphtha feedstock for crackers—poses considerable challenges.

Using pyrolysis oil product as a feed to create new, second-life plastic products through hydroprocessing followed by steam cracking would work to support circular economy. Thus, new, and efficient processes to overcome the inherent challenges in converting pyrolysis oil into steam cracker feedstock would be of great interest to the industry.

### SUMMARY

Against this backdrop the present invention was developed. Presented is a process and catalyst system for making steam cracker feedstocks from pyrolysis oil derived from waste plastics. In one embodiment the system utilizes a hydrotreating section and a hydrocracking section. The use of both reaction units is important. In one embodiment some products can be sent to a steam cracker as feedstocks, while others can be recycled back into the system to improve yield. In one embodiment recycling should result in better heat management. The present system results in the conversion of pyrolysis oil derived from waste plastics into steam cracker feedstock, which is beneficial to the industry.

The present process and catalyst system offers a new efficient process for making steam cracker feedstocks from pyrolysis oil derived from waste plastics.

### BRIEF DESCRIPTION OF THE DRAWINGS

FIG. 1 depicts a flow diagram of one embodiment of the present process of converting waste plastic derived pyrolysis oil into steam cracker feedstock. The process comprises passing the pyrolysis oil through a series of hydrotreating reactors, hydrocracking stages, a hydrocracking fractionation stage, and conveying the effluent to a steam cracker.

FIG. 2 depicts a flow diagram of another embodiment of the present process of converting waste plastic derived pyrolysis oil into steam cracker feedstock. The process comprises passing the pyrolysis oil through a series of hydrotreating reactors, a hydrotreating fractionation stage, hydrocracking stages, a hydrocracking fractionation stage, and conveying the effluent to a steam cracker.

FIG. 3 depicts a bar graph showing the GCxGC results of the hydrotreated (HDTed) pyrolysis oil blend B.

FIG. 4 depicts a scatter plot showing the hydrocracking per pass conversion (PPC) and blend of hydrotreated pyrolysis oil of the blend B.

FIG. 5 depicts a line graph showing hydrocarbon analysis of a naphtha product.

FIG. 6 depicts a bar graph showing the amounts of hydrocarbon (HC) types from the detailed hydrocarbon analysis of a naphtha product.

FIG. 7A depicts a bar graph of GCxGC results of jet fuel product (V₃O).

FIG. 7B depicts a bar graph of GCxGC results of diesel UCO product (V₃B).

FIG. 8 depicts a bar graph showing product hydrocarbon types yields with carbon numbers between 1 and 41.

### DETAILED DESCRIPTION

Before the process and catalyst system for making steam cracker feedstocks from pyrolysis oil derived from waste plastics, is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

This invention disclosure describes a process and catalyst system in making steam cracker feedstocks from pyrolysis oil derived from waste plastics. The waste plastics from which the pyrolysis oil is derived can be from any waste plastics, but in one embodiment, the waste plastics comprise polypropylene and/or polyethylene. In one embodiment, the waste plastics from which the pyrolysis oil is derived comprises at least 1 wt. %, at least 10 wt. % or at least 90 wt. % polyethylene, so the pyrolysis oil derived from the waste plastic comprises at least 1 wt. %, at least 10 wt. %, or at least 90 wt. % polyethylene. In one embodiment, the pyrolysis oil derived from the waste plastic comprises at least 10 wt. % n-paraffins and linear olefins having no branches.

In one embodiment, the present process for the conversion of waste plastic derived pyrolysis oil into steam cracker feedstock includes two sections. A pyrolysis oil hydrotreating (HDT) section, and a hydrocracking section under single stage liquid recycle (SSREC) operational mode. Hydrotreating and hydrocracking are distinctly different catalytic processes, but which also operate at pressures greater than atmospheric in the presence of hydrogen. Hydrocracking converts normal paraffins into lighter products comprising significant amounts of iso-paraffins. Hydrotreating can remove impurities such as sulfur- and nitrogen-containing compounds.

In one embodiment of the present process, the hydrotreating section comprises passing waste plastic pyrolysis oil through two hydrotreating stages and a hydrotreating separation stage. In the stage I HDT reactor, waste plastic pyrolysis oil can be added along with fresh H₂. In one embodiment the catalyst used in the stage I HDT reactor is a wider pore low metal HDT catalyst with higher surface area. Such a catalyst can be useful for olefin saturation, partial Cl removal, handling metal contamination, and use at lower temperatures such as 450° F. In one embodiment 450° F. was selected as the stage I reaction temperature for better heat management. The hydrotreating can generally result in a hydrocarbon product comprising at least 30 wt. % normal paraffins.

The effluent from the stage I HDT reactor can then be passed to a stage II HDT reactor. In one embodiment the catalyst used in the stage II HDT reactor can be a regular hydrotreating catalyst with higher metal loading. Such a catalyst can be useful for deeper hydrodenitrogenation (HDN), hydrodesulfurization (HDS), aromatics saturation, and fuel Cl removal. The now twice hydrotreated effluent can then be passed to a HDT separation stage, along with amine, where the effluent can be separated into desired fractions. In one embodiment H₂ from this separation stage can be recycled back to the stage I HDT reactor and injected alongside the fresh H₂. C₄− gasses from the HDT separation stage can be sent directly to a steam cracker for cracking.

The steam cracking process is known in the art. Steam cracking a hydrocarbon feedstock produces olefin streams containing olefins such as ethylene, propylene, and butenes as well as aromatics. In steam cracking, a gaseous or liquid hydrocarbon feed like ethane, liquefied petroleum gas (LPG), light or full-range naphtha is diluted with steam and heated in a furnace in the absence of oxygen. Typically, the reaction temperature is between 80° and 900° C. and the residence time is on the order of milliseconds. The pyrolyzing gases flow at close to the speed of sound. After pyrolysis, the gas is quickly quenched to stop the reaction in a transfer line heat exchanger or inside a quenching header using quench oil.

The products produced in the reaction depend on the composition of the feed and on the conditions, such as the hydrocarbon-to-steam ratio, the cracking temperature and furnace residence time. Light hydrocarbon feeds (ethane, LPG, light naphtha) yield lighter alkenes, including ethylene, propylene, and butadiene. Heavier hydrocarbon feeds (full range and heavy naphtha, hydrogenated gas oils) also yield these lighter products as well as aromatic pyrolysis oils suitable for aromatics extraction and for use in the production of needle coke or synthetic graphite.

Some fractions of the HDT separation stage require hydrocracking before they can be passed to the steam cracker, and thus a portion of the effluent from the HDT separation stage can be passed instead to a hydrocracking stage along with fresh H₂. In one embodiment, before being sent to the hydrocracking stage, the effluent from the HDT separations stage can be further separated in a HDT fractionation stage to produce C₄− gasses and naphtha, which can both be sent directly to the steam cracker.

Traditional catalysts can be used in the hydrocracking, but in one embodiment the catalyst in the hydrocracking reactor can be a PtPd bimetallic noble metal catalyst supported on LTA zeolite. Base metal catalysts can be supported as well. A LTA (Linde Type A) zeolite is a zeolite that has voids greater than 0.50 nm in diameter, and apertures characterized by a longest diameter of less than 0.5 nm and a shortest diameter of more than 0.30 nm. Such LTA zeolites are described in the Atlas of Zeolite Structure Types, Fourth Revised Edition 1996.

An “aperture” in a zeolite is the narrowest passage through which an absorbing or desorbing molecule needs to pass to get into the zeolite's interior. The diameter of the aperture, dₐₚₚ (nm), is defined as the average of the shortest, dₛₕₒᵣₜ (nm), and the longest, d_{long} (nm) axis provided in the IZA (International Zeolite Association) Zeolite Atlas (http://www.iza-structure.org/databases/). Both normal- and iso-paraffins with a methyl group can pass through apertures with a d_{long}≥0.50 nm, but only normal-paraffins can pass through apertures with d_{long}<0.50 nm provided dₛₕₒᵣₜ>0.30 nm.

Apertures provide access to “voids”, the wider parts in the zeolite topology. The diameter of the void, d_{void} (nm), is characterized by the maximum diameter of a sphere that one can inflate inside such a void as per the IZA Zeolite Atlas (http://www.iza-structure.org/databases/). This characterizes, e.g., a fairly spherical LTA void (or cage) as one with a diameter of 1.1 nm, and an elongated AFX-type void as one with a spherical diameter of 0.78 nm. Voids are defined as cages if d_{void}/dₐₚₚ≥1.4 nm/nm. An LTA zeolite exhibits a topology with a defined combination of apertures and voids.

It is the zeolite-containing base into which the metal is loaded that is critical to the present processes. For it has been found that the present catalyst comprising a LTA zeolite in accordance herewith can provide the high conversion and minimal formation of iso-paraffins. It has been found that the key features of the catalyst zeolite include access to a pore system through apertures of a size less than 0.45 nm, and with the pore system containing voids greater than 0.50 nm in diameter. In another embodiment, the zeolite has voids greater than 0.50 nm in diameter, which are accessible through apertures characterized by a longest diameter of less than 0.5 nm and a shortest diameter of more than 0.30 nm. The LTA zeolite has such a zeolite framework.

LTA zeolites are one of the most used zeolites in separations, adsorption, and ion exchange. This structure contains large spherical cages (diameter ˜11.4 Å) that are connected in three dimensions by small 8-membered ring (8MR) apertures with a diameter of 4.1 Å. LTA is normally synthesized in hydroxide media in the presence of sodium with Si/Al ˜1 mol/mol. By changing the cation, the limiting diameter of the 8MR apertures can be tuned, creating the highly used series of adsorbents 3 A (potassium form, 2.9 Å diameter), 4 A (sodium form, 3.8 Å diameter) and 5 A (calcium form, 4.4 Å diameter) that are used to selectively remove species such as water, NH₃, SO₂, CO₂, H₂S, C₂H₄, C₂H₆, C₃H₆ and other n-paraffins from gases and liquids. Detergents deploy zeolite 4A because it softens water by replacing calcium and magnesium ions in “hard” water with sodium ions. While LTA zeolites are used in vast quantities for the aforementioned applications, the industry has considered the low framework Si/Al ratio and subsequent poor hydrothermal stability limits as limiting factors to succeeding under more demanding process conditions that are commonly found in catalytic applications. Yet surprisingly, the present process is found to be stable and efficient using an LTA zeolite with an acid site concentration of from 2.6 to 3.0 mol/L.

The stability of the present LTA zeolites with 0.4 nm wide constrictions in hydroconverting n-alkanes longer than n-hexane (n-C₆) is stunning. Based on 3 months of operation without activity loss after line-out, current models indicate that a catalyst based on LTA-type zeolite would exhibit the typical run length of 2-4 years for base metal catalyst formulations and of 10-15 years for noble metal catalyst formulations at typical feeds and conditions. The catalyst sustainably hydrocracks extremely long n-paraffins, such as C₂₃⁺ in length. The stability of the hydrocracking process on the LTA-type zeolite catalyst is surprising because it is well-established that a (de) hydrogenation function needs to activate n-paraffins into n-olefins, and that these n-olefins need to enter ˜11 nm wide LTA-type cages before isomerizing into iso-olefins (see J. E. Schmidt et al., ACS Catalysis vol. 13, 2023, pp 6710-6720). These iso-olefins are trapped inside the LTA-type cages, for they are too large to egress through the ˜5 nm wide LTA-type windows (see P. B. Weisz, V. J. Frilette, J. Phys. Chem. vol. 64, 1960, p 382). Well-established mechanisms explain how iso-olefins crack into mixtures of iso-paraffins, iso-olefins, n-paraffins and n-olefins (J. Weitkamp, P. A. Jacobs, J. A. Martens, Appl. Catal. vol. 8, 1983, pp. 123-141). An iso-paraffin would require activation into an iso-olefin to enable isomerization into an n-olefin and escape from the LTA-type cage. Without a noble metal function iso-paraffins would accumulate inside the LTA-type cages, blocking access to the zeolite and deactivating the catalyst. Surprisingly, this deactivation was not observed, so that the catalyst sustainably converted longer n-paraffins into desirable linear paraffins in the C₂-C₆ carbon number range.

The discovered stability of the present LTA zeolites with 0.4 nm wide constrictions that hydrocrack n-C₁₂⁺ and longer n-alkanes out of feed stocks containing such n-paraffins for at least three months is not intuitive. It is not intuitive because n-C₁₂⁺ and longer n-alkanes inherently hydrocrack into branched alkanes. This would imply that the primary branched alkene and alkane products would have further isomerized into n-alkenes so as to egress through 0.4 nm wide constrictors. Particularly for i-butanes (that are allegedly primary cracking products) it is not clear what mechanism would be involved to let them egress.

The discovered hydroprocessing stability of LTA zeolites with an acid concentration as high as 2.7 mol/L is truly a surprise. Previously, it has been shown that the stability is inversely proportional to acid concentration, and the long held belief in the industry is that stable operation requires an acid concentration of at most 1.8 mol/L. To improve the stability of LTA zeolites with a high acid site concentration, methods were developed to place the metals inside the zeolite to little avail. At acid concentrations higher than 1.8 mol/L, catalysts are supposed to coke up or crumble.

The stable operation of the present LTA zeolite with an acid concentration as high as 2.7 mol/L (well above the historically suggested 1.8 mol/L threshold) in the hydro-normalization of n-alkanes as long as n-C₁₂⁺ remains a bit of a mystery and surprise. The present LTA zeolite having the requisite acid site concentration can continue in operation for at least 3 months and even longer, e.g., 6 months to two years or even 5 years or longer. This is counter intuitive, yet this is what has been discovered.

The catalyst based on the present LTA zeolite can typically contain a catalytically active hydrogenation metal. The presence of a catalytically active hydrogenation metal leads to product improvement, especially viscosity index and stability. Typical catalytically active hydrogenation metals include chromium, molybdenum, nickel, vanadium, cobalt, tungsten, zinc, platinum, and palladium. The metals platinum and palladium are especially preferred, with platinum most especially preferred. If platinum and/or palladium is used, the total amount of active hydrogenation metal is typically in the range of 0.1 wt. % to 5 wt. % of the total catalyst, usually from 0.1 wt. % to 2 wt. %.

The zeolite can be loaded with a hydrogenation function metal or a mixture of such metals either as is or bound with a suitable binder, such as silica, alumina, or titania. Such hydrogenating metals are known in the art and have been discussed generally earlier. The preferred metal is typically either a noble metal, such as Pd, Pt, and Au, or a base metal, such as Ni, Mo and W. A mixture of the metals and their sulfides can be used. The loading of the zeolite with the metals can be accomplished by techniques known in the art, such as impregnation or ion exchange. The hydrogenation function metal is loaded on such a selected zeolite to create the catalyst. The created catalyst can then be used in the hydroconversion process. In one embodiment, the present LTA zeolite also exhibits an acid site concentration of from 2.6 to 3.0 mol/L, in one embodiment from 2.6 to 2.8 mol/L, and preferably about 2.7 mol/L. This is an LTA zeolite with a higher alumina concentration than normal.

The effluent from the hydrocracking stage, along with amine, can then be sent to an hydrocracking separation stage. C₄− gasses from this hydrocracking separation stage can be sent directly to a steam cracker for cracking. In one embodiment H₂ from this hydrocracking separation stage can be recycled back to the hydrocracking stage and injected along with the fresh H₂. Also, in this hydrocracking separation stage, wastewater is separated from the hydrocracking separation effluent which is passed to a hydrocracking fractionation stage. Recycle diesel, diesel+jet, and/or whole liquid product (WLP) can be separated at this point as well and recycled back to the initial hydrocracking stage. The hydrocracking fractionation stage produces C₄− gasses, jet fuel, diesel, and naphtha. The C₄− gasses and naphtha can be sent to the steam cracker for cracking. The jet fuel can be removed directly from this stage. The diesel can either be acquired from this stage or sent back to the initial hydrocracking stage.

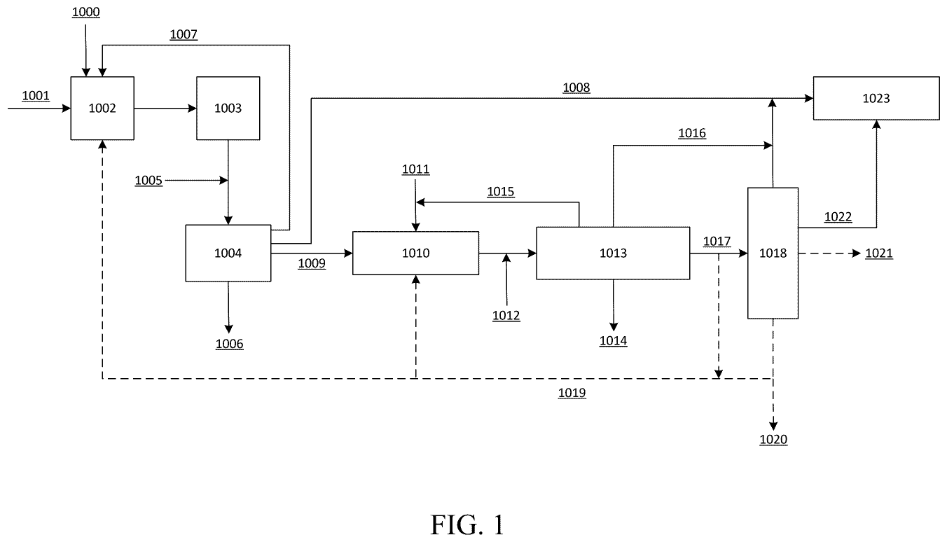

Referring now to the figures of the drawing, FIG. 1 depicts a schematic of one embodiment of the present process. Fresh H₂ 1000, along with waste plastic derived pyrolysis oil 1001 can be provided to a first stage hydrotreating reactor 1002. In one embodiment, the waste plastic derived pyrolysis oil comprises at least 1 wt. %, at least 10 wt. %, or at least 90 wt. % polyethylene. In another embodiment, the waste plastic derived pyrolysis oil comprises at least 10 wt. % n-paraffins and branch free linear olefins. The effluent of the first stage hydrotreating reactor 1002 can be passed to a second stage hydrotreating reactor 1003, wherein amine 1005 can be injected to the effluent of hydrotreating reactor 1003, before the effluent is passed to a hydrotreating separation stage 1004. The hydrotreating separation stage 1004 produces wastewater 1006, recycle H₂ 1007 (which can be sent back to the first stage hydrotreating reactor 1002), C₄− gasses 1008, and an hydrotreatment separation effluent 1009. The hydrotreatment separation effluent 1009 can be passed to a hydrocracking stage 1010 along with fresh H₂ 1011. The effluent of the hydrocracking stage 1010 can be injected with amine 1012 before being passed to a hydrocracking separation stage 1013. The hydrocracking separation stage 1013 produces wastewater 1014, recycle H₂ 1015 (which can be sent back to hydrocracking stage 1010), C₄− gasses 1016, and a hydrocracking separation effluent 1017. The hydrocracking separation effluent can be passed to a hydrocracking fractionation stage 1018, and/or recycled back to the first stage hydrotreating reactor 1002 and/or the hydrocracking stage 1010 as recycle diesel or WLP 1019. The hydrocracking fractionation stage can produce diesel 1020, jet fuel 1021, and naphtha 1022. The naphtha 1022 can be passed to a steam cracker 1023, along with the C₄− gasses 1008.

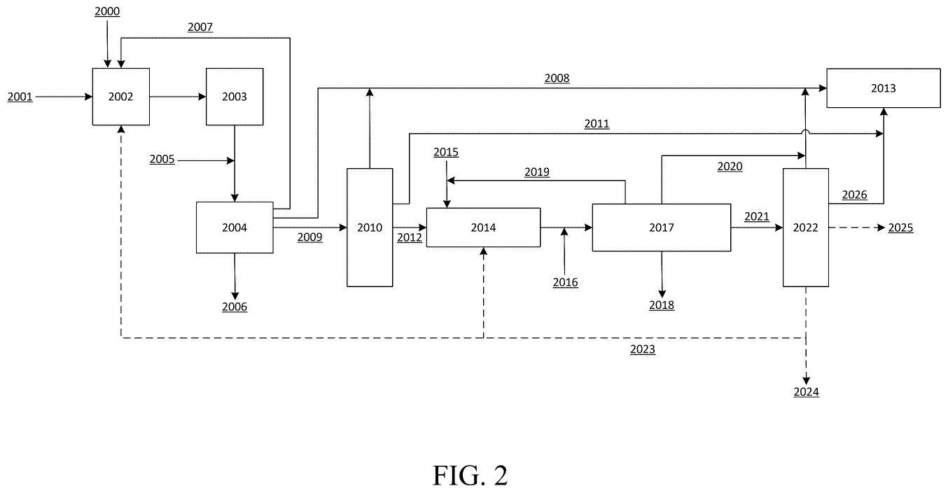

FIG. 2 depicts a schematic of one embodiment of the present process. Fresh H₂ 2000, along with waste plastic derived pyrolysis oil 2001 can be provided to a first stage hydrotreating reactor 2002. The effluent of the first stage hydrotreating reactor 2002 can be passed to a second stage hydrotreating reactor 2003, wherein amine 2005 can be injected to the effluent of hydrotreating reactor 2003, before the effluent is passed to a hydrotreating separation stage 2004. The hydrotreating separation stage 2004 produces wastewater 2006, recycle H₂ 2007 (which can be sent back to the first stage hydrotreating reactor 2002), C₄− gasses 2008, and an hydrotreatment separation effluent 2009. The hydrotreatment separation effluent 2009 can be passed to a hydrotreating fractionation stage 2010. Naphtha 2011, one product of the hydrotreating fractionation stage 2010, can be passed to a steam cracker 2013, and another product, heavier fraction 2012, can be passed to a hydrocracking stage 2014 along with fresh H₂ 2015. The effluent of the hydrocracking stage 2014 can be injected with amine 2016 before being passed to a hydrocracking separation stage 2017. The hydrocracking separation stage 2017 produces wastewater 2018, recycle H₂ 2019 (which can be sent back to hydrocracking stage 2014), C₄− gasses 2020, and a hydrocracking separation effluent 2021. The hydrocracking separation effluent can be passed to an hydrocracking fractionation stage 2022, and/or recycled back to the first stage hydrotreating reactor 2002 and/or the hydrocracking stage 2014 as recycle diesel or WLP 2023. The hydrocracking fractionation stage can produce diesel 2024, jet fuel 2025, and naphtha 2026. The naphtha 2026 can be passed to a steam cracker 2013, along with the C₄− gasses 2008 and 2020.

The remaining figures are best understood and described within the context of the following example and thusly are described below.

### Example of Present Process Scheme, Testing, and Results

To provide an understanding of the benefits offered by the product of the present process, a pyrolysis oil blend derived from waste plastics, labeled A, was prepared. This blend comprises considerable amounts of S, N, Cl, and O, all of which are undesirable for pyrolysis oil being used as a steam cracking feedstock. The bulk properties of A are further described in Table 1, where they are compared to blend B, a hydrotreated pyrolysis oil prepared using the present hydrotreating process.

TABLE 1

Oil Sample

| | | B |
|---|---|---|
| | A | WLP Blend of |
| | Pyrolysis Oil | Hydrotreated |
| | Blend | Pyrolysis Oil |
| API Gravity | 46.7 | 45.8 |
| Density, Kg/L | 0.794 | 0.798 |
| S, ppm | 191 | 6.5 |
| N, ppm | 382 | 1.1 |
| H, wt % by NMR | 13.94 | 14.3 |
| Cl, ppm | 8 | <1.0 |
| Br, ppm | 0.8 | N/A |
| F, ppm | 0.8 | N/A |
| Oxygen, wt % | 0.16 | 0.00 |
| Bromine Number, gBr/100 g | 27 | 0.5 |
| sample | | |
| Karl Fischer Water, ppm | 68 | 24 |
| Pour point, ° C. | 12 | 21 |
| Metal content by ICP, ppm | | |
| Al | ND | ND |
| Fe | 2.33 | ND |
| K | ND | ND |
| Mg | ND | ND |
| P | 2.56 | ND |
| Pb | ND | ND |
| Si | 7.59 | 2.42 |
| Sn | ND | ND |
| Ti | ND | ND |
| V | ND | ND |
| Zn | ND | ND |
| GC-MS Hydrocarbon Types, | | |
| vol % | | |
| Paraffins | N/A | 65.30 |
| Naphthenes | N/A | 25.40 |
| Aromatics | N/A | 9.30 |
| Sulfur | N/A | 0.00 |
| Simdist (wt %), ° F. | | |
| 0.5 | 97 | 102 |
| 5 | 182 | 213 |
| 10 | 241 | 263 |
| 15 | 271 | 295 |
| 20 | 297 | 345 |
| 25 | 328 | 371 |
| 30 | 360 | 392 |
| 35 | 389 | 423 |
| 40 | 422 | 455 |
| 45 | 451 | 477 |
| 50 | 473 | 505 |
| 55 | 504 | 527 |
| 60 | 530 | 555 |
| 65 | 563 | 585 |
| 70 | 597 | 620 |
| 75 | 628 | 652 |
| 80 | 673 | 694 |
| 85 | 716 | 736 |
| 90 | 771 | 789 |
| 95 | 845 | 870 |
| 99 | 1027 | 1015 |
| 99.5 | 1084 | 1076 |

Also described in Table I are the bulk properties of the blended, hydrotreated whole liquid products, labeled B. In comparing blend A to blend B. 100% Cl removal, almost 100% olefin saturation, and considerable amounts of N and S removal and pour point increase have been achieved.

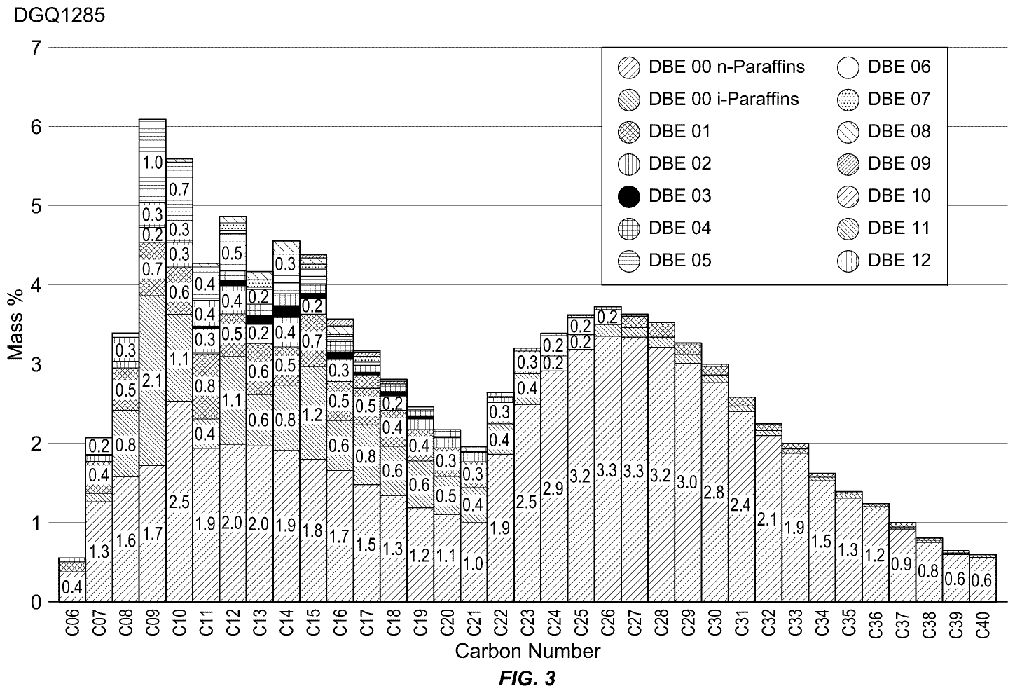

The hydrotreated blend B was analyzed using GCxGC, and the results of the analysis are depicted graphically in FIG. 3, and it shows that normal paraffins are dominant in the hydrotreated pyrolysis oil, which contains 64.34 wt % n-paraffins.

Table 2 depicts the product yield structures of the pyrolysis oil hydrotreating reaction. Blend A was hydrotreated under the following conditions: Total pressure=1000 psi, Total H₂/Oil=5000 SCFB, Total LHSV=1.0 h−1, Catalyst system: Stage I HDT catalyst ICR 187, Stage II HDT catalyst ICR 514, ICR 187/ICR 514=50/50 vol/vol, Stage 1 CAT 450-500° F., Stage II CAT 650-700° F. The H₂ consumption for the hydrotreating reaction was as low as ˜240 SCFB and the product yield structures are like that of the feed.

TABLE 2

| | Pyrolysis | | | | | |
|---|---|---|---|---|---|---|
| PP Run # | Oil | HDT | | | HCR SSREC | |
| Run Hour | Blend A | 864 | 984 | 1008 | 960 | 1176 |
| Catalyst System | N/A | ICR 187/514 | | | PtPd/LTA | |
| Reactor 1 (R1) | N/A | 490 | 500 | 500 | 650 | 650 |
| CAT, ° F. | | | | | | |
| Reactor 2 (R2) | N/A | 680 | 680 | 680 | N/A | N/A |
| CAT, ° F. | | | | | | |
| Total P, psig | N/A | 1000 | 1000 | 1000 | 2300 | 2300 |
| No Loss Yields, Wt % | | | | | | |
| C₄− Gasses | N/A | 0.3 | 0.3 | 0.3 | 12.0 | 9.7 |
| C5-180° F. | 3.1 | 4.5 | 4.5 | 4.5 | 16.9 | 15.8 |
| 180-400° F. | 28.2 | 27.2 | 27.5 | 27.8 | 40.0 | 39.8 |
| 400-540° F. | 26.9 | 25.9 | 25.5 | 25.4 | 23.6 | 24.2 |
| 540-650° F. | 16.8 | 18.0 | 18.2 | 18.2 | 6.5 | 7.7 |
| 650° F.+ | 25 | 24.5 | 24.1 | 24.2 | 4.2 | 5.6 |
| C₅+ | N/A | 100.0 | 99.9 | 99.9 | 91.0 | 93.1 |
| Mass Closure, Wt % | N/A | 99.0 | 97.0 | 99.1 | 99.7 | 98.7 |
| H₂ Consumption, | N/A | N/A | 224 | 242 | 620 | N/A |
| SCFB | | | | | | |
| Recycle Cut Point | N/A | N/A | N/A | N/A | 540 | 540 |
| (RCP), ° F. | | | | | | |
| Per Pass Conversion | N/A | N/A | N/A | N/A | 69.1 | 67.3 |
| (PPC), vol % | | | | | | |

Hydrotreated pyrolysis oil blend B was hydrocracked under the following conditions according to one embodiment of the present process: Total Pressure=1150 psi followed by 2300 psi, Total H₂/Oil=5000 SCFB, Fresh LHSV=1.0 h−1, Catalyst: PtPd/LTA noble metal zeolite catalyst, Operational modes: SSOT follow by SSREC at RCP at 400° F. and then at 540° F.

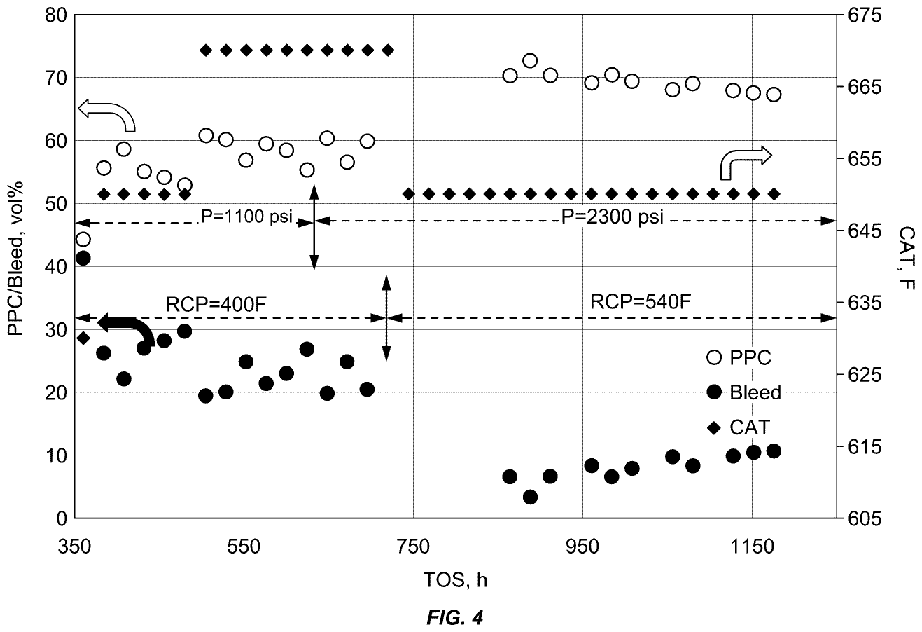

The product yield results and properties under different operational modes are summarized in Tables 2 and 3, and graphically in FIG. 4. Approximately 60% PPC and 20% bleed achieved at CAT at 670° F. and RCP at 400° F. After changing RCP to ˜540° F., approximately 70% PPC and 10% bleed achieved at CAT at 670° F. n-Butane is dominant for runs under both SSOT and SSREC modes. The H₂ consumption is less than 1000 SCFB.

TABLE 3
Product yields and structures of hydrocracking of HDTed pyrolysis oil WLP

| | | | SSREC & | | | SSREC & | |
|---|---|---|---|---|---|---|---|
| | SSOT | | RCP = 400° F. | | | RCP = 540° F. | |
| Catalyst | PtPd/LTA | | | | | | |
| Run Hour | 312 | 336 | 528 | 600 | 696 | 960 | 1176 |
| Temp., ° F. | 620 | 620 | 670 | 670 | 670 | 650 | 650 |
| LHSV R1, h⁻¹ | 1.001 | 1.001 | 1 | 1.028 | 1 | 1 | 1 |
| Total P, psig | 1150 | 1150 | 1150 | 1150 | 2300 | 2300 | 2300 |
| Inlet H₂ P, psia | 1056 | 1056 | 1081 | 1079 | 2149 | 2226 | 2149 |
| No Loss Yields, | | | | | | | |
| Wt % | | | | | | | |
| Methane | 0.13 | 0.13 | 0.31 | 0.30 | 0.32 | 0.17 | 0.14 |
| Ethane | 0.05 | 0.06 | 0.16 | 0.15 | 0.14 | 0.08 | 0.06 |
| Propane | 4.54 | 5.07 | 8.83 | 8.55 | 6.51 | 4.79 | 3.81 |
| i-Butane | 1.15 | 1.37 | 2.54 | 2.47 | 2.34 | 1.78 | 1.43 |
| n-Butane | 4.99 | 5.71 | 9.81 | 9.79 | 6.93 | 5.16 | 4.27 |
| n-C₄/i-C₄ wt/wt | 4.3 | 4.2 | 3.9 | 4.0 | 3.0 | 2.9 | 3.0 |
| Total C₄− | 10.9 | 12.3 | 21.7 | 21.3 | 16.2 | 12.0 | 9.7 |
| C₅-180° F. | 16.1 | 16.2 | 23.7 | 22.8 | 21.7 | 16.9 | 15.8 |
| 180-400° F. | 33.4 | 33.3 | 33.7 | 31.0 | 39.5 | 40.0 | 39.8 |
| 400-540° F. | 21.2 | 20.9 | 14.8 | 15.2 | 14.7 | 23.6 | 24.2 |
| 540-650° F. | 10.2 | 10.4 | 5.5 | 6.4 | 5.3 | 6.5 | 7.7 |
| 650° F.+ | 9.3 | 9.4 | 3.9 | 4.8 | 4.0 | 4.2 | 5.6 |
| C₅+ | 91.5 | 90.2 | 81.5 | 81.5 | 86.6 | 90.5 | 93.1 |
| Mass Closure, | 98.0 | 100.1 | 98.5 | 99.8 | 98.6 | 98.8 | 98.7 |
| Wt % | | | | | | | |
| Chem H₂ | 583 | N/A | N/A | N/A | 701 | 620 | N/A |
| Consumption, | | | | | | | |
| SCFB | | | | | | | |
| App Conv of | 90.73 | 90.62 | 96.09 | 95.22 | 96.03 | 95.8 | 94.37 |
| 650° F.+ wt % | | | | | | | |
| App Conv of | 68.6 | 68.7 | 79.8 | 78.4 | 80.1 | 70.0 | 68.2 |
| 540° F.+, wt % | | | | | | | |
| App Conv of | 59.3 | 59.3 | 75.9 | 73.7 | 76.1 | 65.8 | 62.5 |
| 400° F.+, wt % | | | | | | | |
| Recycle Cut Point | N/A | N/A | 400 | 400 | 400 | 540 | 540 |
| (RCP), ° F. | | | | | | | |
| Per Pass | N/A | N/A | 60.13 | 58.35 | 59.94 | 69.05 | 67.27 |
| Conversion (PPC), | | | | | | | |
| vol % | | | | | | | |
| Bleed, vol % | N/A | N/A | 20.15 | 23.06 | 20.44 | 8.35 | 10.70 |
| STO Product | | | | | | | |
| API Gravity | 63.2 | 63.3 | 64.60 | 64.60 | 64.00 | 63.60 | 63.10 |
| Simdist (wt %), ° F. | | | | | | | |
| 0.5/5 | 31/99 | 25/97 | −6/75 | −6/75 | −14/93 | −4/96 | 2/96 |
| 10/30 | 136/211 | 135/209 | 98/169 | 98/170 | 98/196 | 134/209 | 136/210 |
| 50 | 272 | 270 | 258 | 259 | 268 | 270 | 271 |
| 70/90 | 334/386 | 332/385 | 328/390 | 326/388 | 329/387 | 321/382 | 332/385 |
| 95/99.5 | 399/424 | 398/422 | 411/445 | 410/445 | 408/442 | 397/430 | 404/435 |
| V3O product | | | | | | | |
| API Gravity | 43.3 | 43.4 | N/A | N/A | N/A | 44.60 | 44.80 |
| Simdist (wt %), ° F. | | | | | | | |
| 0.5/5 | 332/386 | 330/386 | N/A | N/A | N/A | 291/362 | 292/364 |
| 10/30 | 413/448 | 410/447 | N/A | N/A | N/A | 385/437 | 386/441 |
| 50 | 473 | 473 | N/A | N/A | N/A | 466 | 469 |
| 70/90 | 504/535 | 504/535 | N/A | N/A | N/A | 502/540 | 503/540 |
| 95/99.5 | 546/563 | 545/563 | N/A | N/A | N/A | 552/577 | 551/577 |
| STB/V3B product | V3B | | | | | | |
| API | 38.39 | 38.37 | 39.86 | 39.31 | 40.33 | 39.88 | 39.97 |
| Simdist (wt %), ° F. | | | | | | | |
| 0.5/5 | 511/548 | 518/549 | 341/393 | 345/403 | 338/389 | 458/537 | 456/536 |
| 10/30 | 562/599 | 562/599 | 426/469 | 433/477 | 424/470 | 557/599 | 557/599 |
| 50 | 651 | 650 | 522 | 5302 | 522 | 649 | 649 |
| 70/90 | 723/852 | 720/846 | 589/714 | 598/726 | 588/725 | 716/847 | 716/842 |
| 95/99.5 | 940/1127 | 926/1116 | 778/977 | 790/989 | 802/1054 | 937/1121 | 927/1117 |

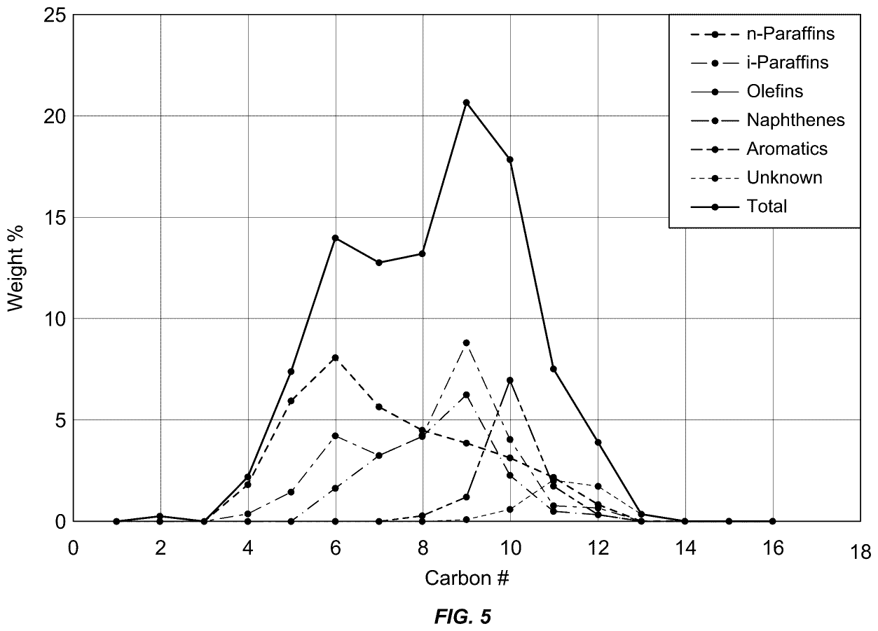

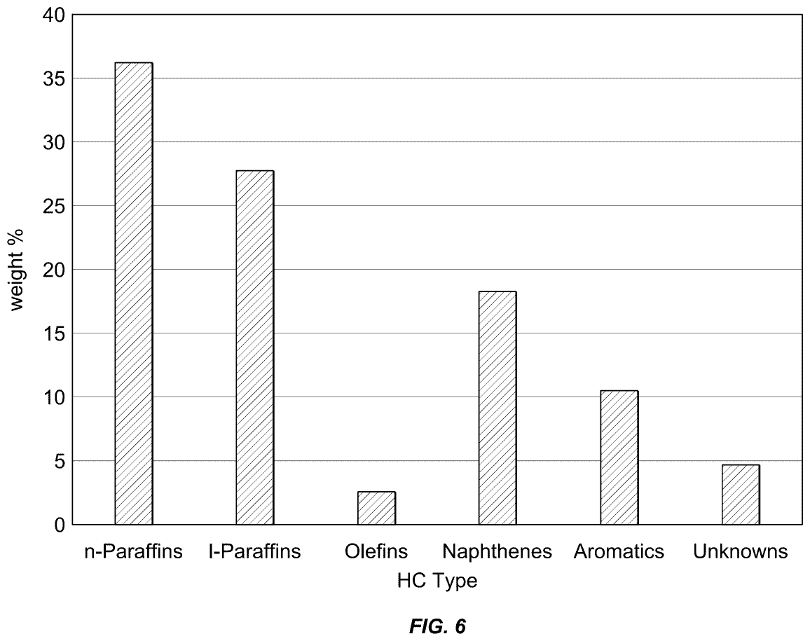

The naphtha product from 960 h with PPC at 69 vol % and RCP at 541° F. (and bleed rate at 8 wt. %) was studied by detailed hydrocarbon analysis and the results are summarized graphically in FIGS. 5-6. n-Paraffins (˜36 wt. % of total naphtha) are dominant.

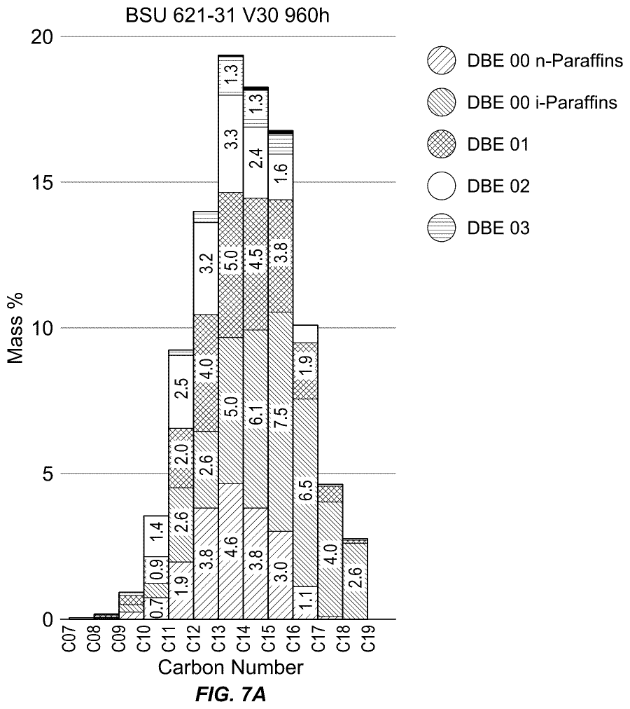

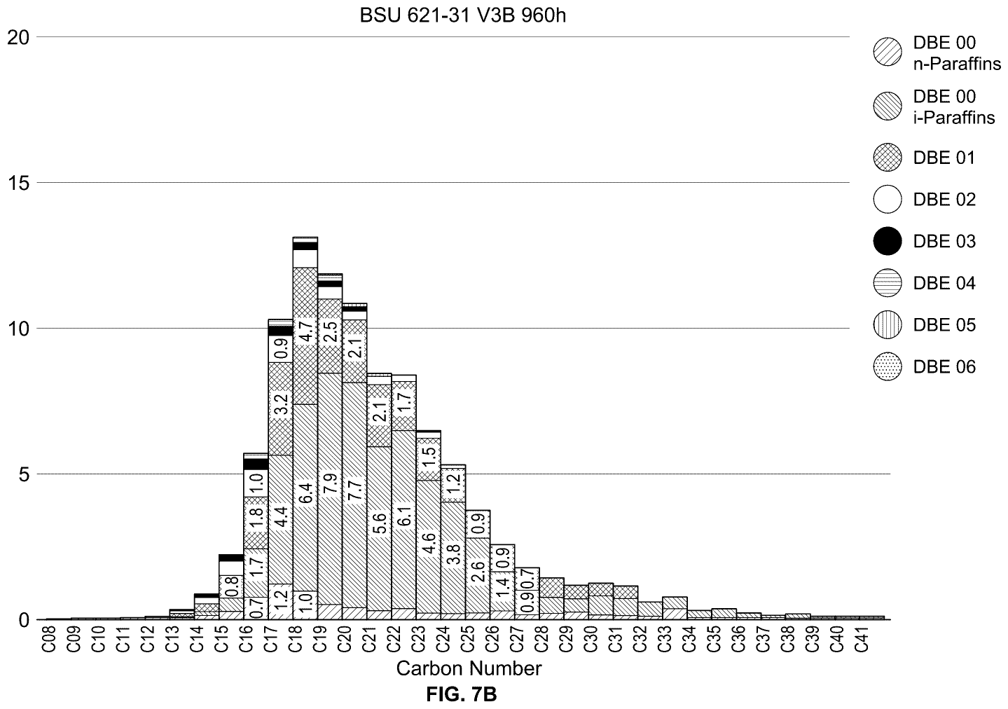

The jet fuel product (V₃O) and diesel unconverted product (V₃B) from the same 960 h reaction were analyzed by GCxGC to get the molecular level distribution of the products as shown in FIGS. 7A and 7B, respectively. Comparing with the results from FIG. 3, it is clear that naphtha product contains highest amount of n-paraffins and diesel unconverted product contains the least amount of n-paraffins.

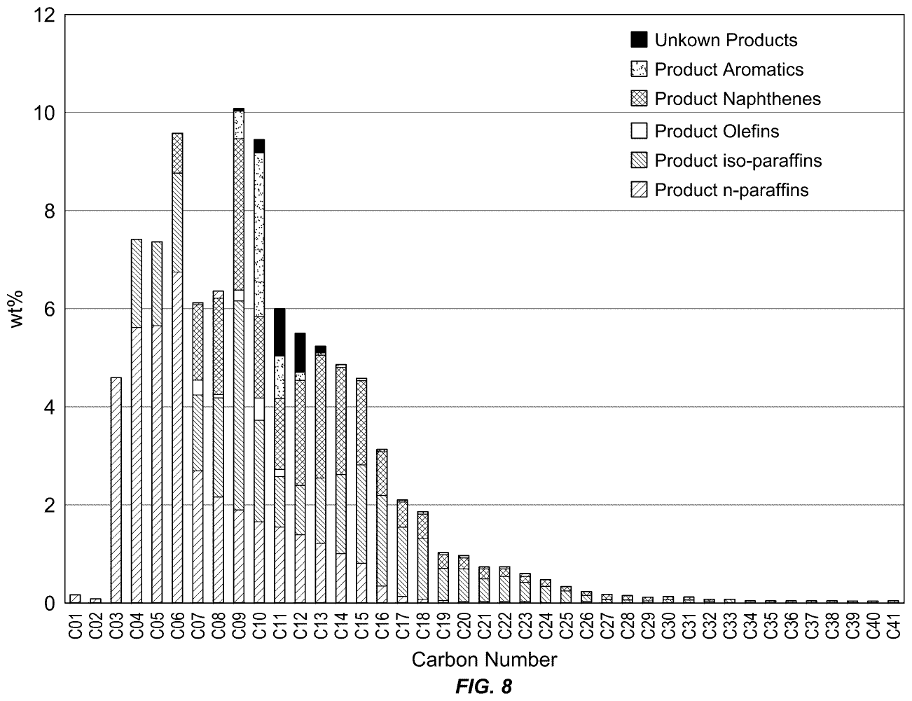

The regular product yield structure of the products of the 960 h reaction was then converted to hydrocarbon (HC) types yield with carbon numbers between 1 and 41 as graphically shown in FIG. 8. C₂₅+ HCs in feed are almost all cracked to light HCs and n-C₁+ paraffins are cracked to light n-paraffins and iso-paraffins, and n-paraffins are dominant in the hydrocracked product. N—C₁₂+'s apparent conversion is 90 wt. %.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements except for only minor traces of impurities.

As those skilled in the art will appreciate, numerous modifications and variations of the present invention are possible considering these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A process for the conversion of waste plastic derived pyrolysis oil into steam cracker feedstock comprising:
a) providing waste plastic derived pyrolysis oil to a hydrotreatment stage;
b) hydrotreating the waste plastic derived pyrolysis oils, which results in a hydrocarbon product comprising at least 30 wt. % normal paraffins;
c) separating the effluent of the hydrotreatment stage;
d) providing a portion of the effluent of the hydrotreatment stage to a hydrocracking stage;
e) providing a portion of the effluent to a steam cracker;
f) cracking the heavy product effluent;
g) separating the effluent of the hydrocracking stage; and
h) providing a portion of the effluent of the hydrocracking stage to said steam cracker.

2. The process of claim 1, wherein the hydrotreatment stage comprises one or more hydrotreatment steps.

3. The process of claim 1, wherein the portion of the effluent of the hydrotreatment stage being passed to the hydrocracking stage is first passed through a hydrotreating fractionation step.

4. The process of claim 2, wherein a first hydrotreatment step utilizes a wide pore, low metal catalyst with a high surface area.

5. The process of claim 2, wherein a second hydrotreatment step utilizes a regular hydrotreating catalyst with higher metal loading.

6. The process of claim 1, wherein cracking the heavy product effluent comprises the use of an LTA zeolite.

7. The process of claim 2, wherein the LTA zeolite supports a PtPd bimetallic noble metal catalyst.

8. The process of claim 2, wherein the acid site concentration of the LTA-type zeolite is about 2.6 to 3.0 mol/l.

9. The process of claim 2, wherein the acid site concentration of the LTA-type zeolite is about 2.7 mol/l.

10. The process of claim 1, wherein the effluent passed to the steam cracker is a n-paraffin rich naphtha stream.

11. The process of claim 1, wherein at least a portion of the effluent of the hydrocracking stage is recycled to step b).

12. The process of claim 1, wherein at least a portion of the effluent of the hydrocracking stage is recycled to step d).

13. The process of claim 1, wherein the waste plastic derived pyrolysis oil in step a) comprises at least 1 wt. % polyethylene.

14. The process of claim 13, wherein the waste plastic derived pyrolysis oil comprises at least 10 wt. % polyethylene.

15. The process of claim 13, wherein the waste plastic derived pyrolysis oil comprises at least 90 wt. % polyethylene.

16. The process of claim 1, wherein the waste plastic derived pyrolysis oil in step a) comprises at least 10 wt. % n-paraffins.

17. The process of claim 16, wherein the waste plastic derived pyrolysis oil comprises at least 10 wt. % n-paraffins and linear olefins which are free of branches.
